(19) United States
(12) Patent Application Publication
(10) Pub. No.: US 2020/0057725 A1
(43) Pub. Date: Feb. 20, 2020

(54) DATA STORAGE DEVICE AND OPERATING METHOD THEREOF

(71) Applicant: SK hynix Inc., Gyeonggi-do (KR)

(72) Inventors: Young Ick CHO, Seoul (KR); Sung Kwan HONG, Seoul (KR)

(21) Appl. No.: 16/523,508

(22) Filed: Jul. 26, 2019

(30) Foreign Application Priority Data
Aug. 17, 2018 (KR) 10-2018-0096206

(51) Int. Cl. G06F 12/10

(52) U.S. Cl. CPC G06F 12/10; G06F 2212/657

(57) ABSTRACT

A data storage device may include: a nonvolatile memory device including a first memory block and a second memory block; and a processor configured to generate an invalid entry including first physical block addresses of the first memory block, corresponding to sequential logical block addresses, and generate a valid entry including second physical block addresses of the second memory block, in which data for the sequential logical block addresses are to be stored, collectively change, based on the invalid entry, bits corresponding to the first physical block addresses in a first valid page bitmap table of the first memory block to a first value, and collectively change, based on the valid entry, bits corresponding to the second physical block addresses in a second valid page bitmap table of the second memory block to a second value.

### CROSS-REFERENCE TO RELATED APPLICATION

The present application claims priority under 35 U.S.C. § 119(a) to Korean application number 10-2018-0096206, filed on Aug. 17, 2018, in the Korean Intellectual Property Office, which is incorporated herein by reference in its entirety.

### BACKGROUND

### 1. Technical Field

Various embodiments of the present disclosure generally relate to an electronic device, and more particularly, to a data storage device and an operating method thereof.

### 2. Related Art

Recently, the paradigm for the computing environment has shifted to the ubiquitous computing environment in which computer systems can be used anytime and anywhere. Therefore, the use of portable electronic devices such as mobile phones, digital cameras and notebook computers has rapidly increased. The portable electronic devices generally use a data storage device using a memory device. The data storage device is used to store data which are used in the portable electronic device.

Since the data storage device using a memory device has no mechanical driver, the data storage device has excellent stability and durability, high information access speed, and low power consumption. A data storage device having such advantages includes a universal serial bus (USB) memory device, a memory card having various interfaces, a universal flash storage (UFS) device, and a solid state drive (SSD).

### SUMMARY

Various embodiments are directed to a data storage device capable of reducing an overhead required for managing valid data, and an operating method thereof.

In an embodiment, a data storage device may include: a nonvolatile memory device including a first memory block and a second memory block; and a processor configured to generate an invalid entry including first physical block addresses of the first memory block, corresponding to sequential logical block addresses, and generate a valid entry including second physical block addresses of the second memory block, in which data for the sequential logical block addresses are to be stored, when the sequential logical block addresses corresponding to data stored in the first memory block and a write request are received from a host device, collectively change, based on the invalid entry, bits corresponding to the first physical block addresses in a first valid page bitmap table of the first memory block to a first value, and collectively change, based on the valid entry, bits corresponding to the second physical block addresses in a second valid page bitmap table of the second memory block to a second value.

In an embodiment, an operating method of a data storage device may include: receiving a write request and sequential logical block addresses from a host device; loading on a memory one or more map segments including the sequential logical block addresses from a nonvolatile memory device; controlling the nonvolatile memory device to perform a write operation according to the write request; generating an invalid entry including first physical block addresses corresponding to the sequential logical block addresses and a valid entry including second physical block addresses corresponding to the sequential logical block addresses; and collectively changing bits corresponding to the first physical block addresses to a first value within an invalid page bitmap table based on the invalid entry, and collectively changing bits corresponding to the second physical block addresses to a second value within a valid page bitmap table based on the valid entry.

In an embodiment, a data storage device may include: a nonvolatile memory device, including a first block currently storing first data and an open second block, and configured to store first and second tables respectively indicating validity of data stored in each storage region within the first and second blocks; and a control component configured to control the nonvolatile memory device to program second data into the second block; and update the first table to indicate the first data as invalid and the second table to indicate the second data as valid. The first and second data correspond to the same sequential logical addresses.

### BRIEF DESCRIPTION OF THE DRAWINGS

FIG. 1 illustrates a data storage device in accordance with an embodiment.

FIG. 2 illustrates a memory, such as that of FIG. 1.

FIG. 3A illustrates a flash translation layer (FTL), such as that of FIG. 2.

FIG. 3B illustrates a metadata region, such as that of FIG. 2.

FIG. 3C illustrates a structure of a valid information update entry list, such as that of FIG. 3B.

FIG. 3D illustrates a valid information storage region, such as that of FIG. 3B.

FIG. 3E illustrates a structure of a valid page bitmap table.

FIG. 4A illustrates an address buffer, such as that of FIG. 2.

FIG. 4B illustrates an open memory block.

FIG. 5 illustrates an address mapping table, such as that of FIG. 1.

FIG. 6 illustrates a process of generating and storing a valid information update entry and collectively updating the valid page bitmap table in accordance with an embodiment.

FIG. 7 is a flowchart illustrating an operating method of a data storage device in accordance with an embodiment.

FIG. 8 illustrates a data processing system including a solid state drive (SSD) in accordance with an embodiment.

FIG. 9 illustrates a controller, such as that illustrated in FIG. 8.

FIG. 10 illustrates a data processing system including a data storage apparatus in accordance with an embodiment.

FIG. 11 illustrates a data processing system including a data storage apparatus in accordance with an embodiment.

FIG. 12 illustrates a network system including a data storage apparatus in accordance with an embodiment.

FIG. 13 illustrates a nonvolatile memory device included in a data storage apparatus in accordance with an embodiment.

### DETAILED DESCRIPTION

A data storage device and an operating method thereof are described below with reference to the accompanying drawings through various embodiments. Throughout the specification, reference to “an embodiment” or the like is not necessarily to only one embodiment, and different references to any such phrase are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Communication between two elements, whether directly or indirectly connected/coupled, may be wired or wireless, unless stated or the context indicates otherwise.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

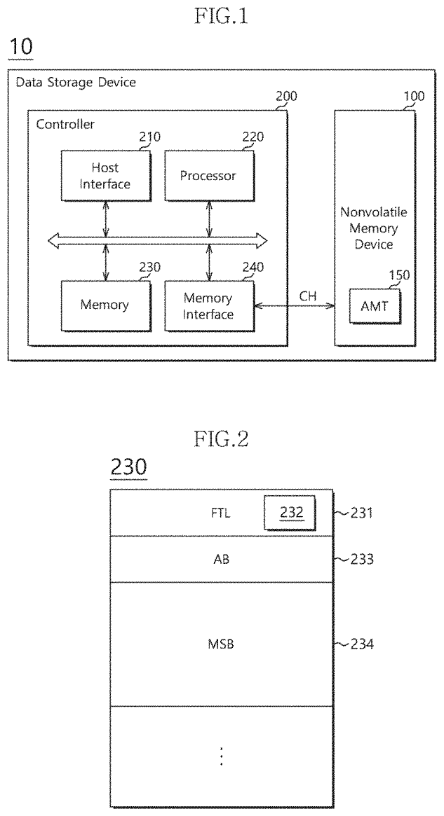

FIG. 1 illustrates a configuration of a data storage device 10 in accordance with an embodiment.

Referring to FIG. 1, the data storage device 10 may store data accessed by a host device (not illustrated), such as a mobile phone, MP3 player, laptop computer, desktop computer, game machine, TV or in-vehicle infotainment system. The data storage device 10 may be referred to as a memory system.

The data storage device 10 may be configured as any of various types of storage devices, depending on an interface protocol coupled to the host device. For example, the data storage device 10 may be implemented as any of a solid state drive (SSD), a multimedia card (MMC) such as an eMMC, RS-MMC or micro-MMC, a secure digital (SD) card such as a mini-SD or micro-SD, a universal serial bus (USB) storage device, a universal flash storage (UFS) device, a personal computer memory card international association (PCMCIA) card-type storage device, a peripheral component interconnection (PCI) card-type storage device, a PCI express (PCI-E) card-type storage device, a compact flash (CF) card, a smart media card and a memory stick.

The data storage device 10 may be fabricated as any of various types of packages, such as a package-on-package (POP), a system-in-package (SIP), a system-on-chip (SOC), a multi-chip package (MCP), a chip-on-board (COB), a wafer-level fabricated package (WFP) or a wafer-level stack package (WSP).

The data storage device 10 may include a nonvolatile memory device 100 and a controller 200.

The nonvolatile memory device 100 may operate as a storage medium of the data storage device 10. The nonvolatile memory device 100 may be implemented as any of various types of nonvolatile memory devices, such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PRAM) using chalcogenide alloys, or a resistive random access memory (ReRAM) using a transition metal oxide, depending on memory cells.

FIG. 1 illustrates a single instance of a nonvolatile memory device 100 for clarity, but this is only an example. The data storage device 10 may include a plurality of nonvolatile memory devices 100, and the present invention may also be applied in the same manner to the data storage device 10 including the plurality of nonvolatile memory devices 100.

The nonvolatile memory device 100 may include a memory cell array (not illustrated) having a plurality of memory cells arranged at respective intersections between a plurality of bit lines (not illustrated) and a plurality of word lines (not illustrated). The memory cell array may include a plurality of memory blocks, and each of the memory blocks may include a plurality of pages.

For example, each of the memory cells of the memory cell array may be a single level cell (SLC) for storing 1-bit data, a multi-level cell (MLC) for storing 2-bit data, a triple level cell (TLC) for storing 3-bit data, or a quadruple level cell (QLC) for storing 4-bit data. A memory cell array 110 may include one or more of the SLC, the MLC, the TLC and the QLC. Also, the memory cell array 110 may include memory cells with a two-dimensional horizontal structure or memory cells with a three-dimensional vertical structure.

The controller 200 may control overall operations of the data storage device 10 by driving firmware or software loaded to the memory 230. The controller 200 may decode and drive a code-based instruction or algorithm such as firmware or software. The controller 200 may be implemented in hardware or a combination of hardware and software.

The controller 200 may include a host interface 210, a processor 220, a memory 230 and a memory interface 240. Although not illustrated in FIG. 1, the controller 200 may further include an error correction code (ECC) engine which generates parity data by performing ECC encoding on write data provided from a host device, and performs ECC decoding on read data read from the nonvolatile memory device 100 using the parity data.

The host interface 210 may interface the host device and the data storage device 10 in response to a protocol of the host device. For example, the host interface 210 may communicate with the host device through any of various protocols, including USB (universal serial bus), UFS (universal flash storage), MMC (multimedia card), PATA (parallel advanced technology attachment), SATA (serial advanced technology attachment), SCSI (small computer system interface), SAS (serial attached SCSI), PCI (peripheral component interconnection) and PCI-E (PCI express).

The processor 220 may include a micro control unit (MCU) and/or a central processing unit (CPU). The processor 220 may process a request transferred from the host device. In order to process the request transferred from the host device, the processor 220 may drive a code-based instruction or algorithm, i.e. firmware, which is loaded to the memory 230, and control the nonvolatile memory device 100 and internal function blocks such as the host interface 210, the memory 230 and the memory interface 240.

The processor 220 may generate control signals for controlling an operation of the nonvolatile memory device 100, based on requests transferred from the host device, and provide the generated control signals to the nonvolatile memory device 100 through the memory interface 240.

The memory 230 may be configured as a RAM such as a dynamic RAM (DRAM) or static RAM (SRAM). The memory 230 may store the firmware driven by the processor 220. Furthermore, the memory 230 may store data required for driving the firmware, for example, metadata. That is, the memory 230 may operate as a working memory of the processor 220.

The memory 230 may include a buffer for temporarily storing write data to be transferred to the nonvolatile memory device 100 from the host device or read data to be transferred to the host device from the nonvolatile memory device 100. That is, the memory 230 may operate as a buffer memory.

The memory interface 240 may control the nonvolatile memory device 100 under control of the processor 220. The memory interface 240 may also be referred to as a memory controller. The memory interface 240 may provide the control signals generated by the processor 220 to the nonvolatile memory device 100. The control signals may include a command, address and operation control signal for controlling the nonvolatile memory device 100. The memory interface 240 may provide write data to the nonvolatile memory device 100, or receive read data from the nonvolatile memory device 100.

FIG. 2 illustrates the memory 230 of FIG. 1.

Referring to FIG. 2, the memory 230 in accordance with an embodiment may include a first region 231, a second region 233 and a third region 234. Although not shown, the memory 230 may include one or more other regions for storing various data. For example, the memory 230 may further include a command queue region for queuing commands which are generated based on requests received from the host device, a write data buffer region for storing write data, and a read data buffer region for storing read data.

The first region 231 of the memory 230 may store a flash translation layer (FTL). The FTL may be software driven by the processor 220. The processor 220 may drive the FTL to control a operation of the nonvolatile memory device 100, and provide device compatibility to the host device. As the FTL is driven, the data storage device 10 may be recognized and used as a general data storage device such as a hard disk by the host device. The FTL may include modules for performing various functions.

The FTL may be stored in a system region (not illustrated) of the nonvolatile memory device 100. While the data storage device 10 is booted up, the FTL may be read from the system region of the nonvolatile memory device 100 and stored in the first region 231 of the memory 230.

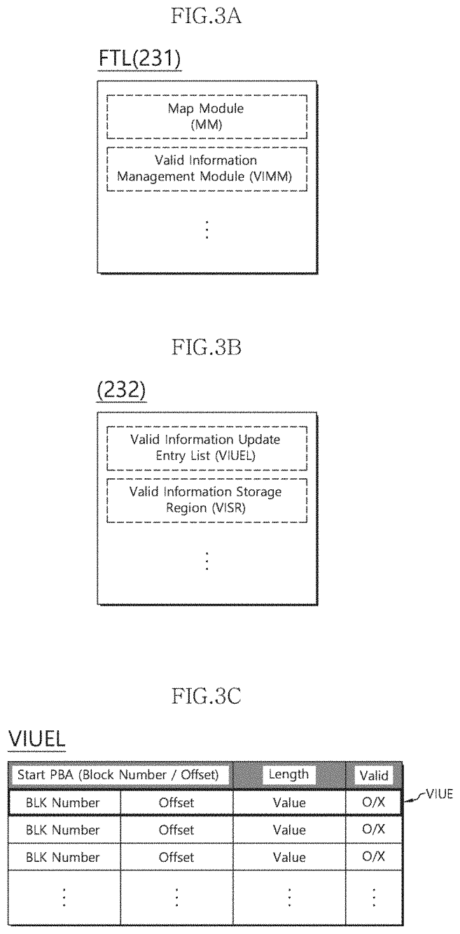

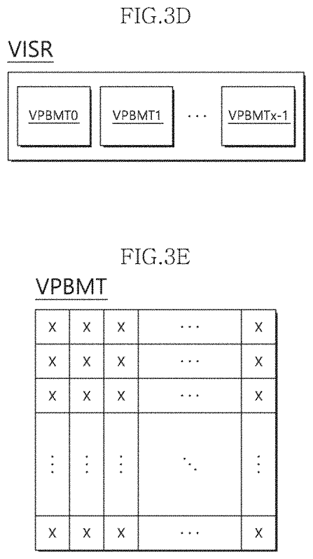

The first region 231 of the memory 230 may include a metadata region 232 for storing metadata required for driving various modules included in the FTL. The metadata stored in the metadata region 232 will be described below with reference to FIG. 3B.

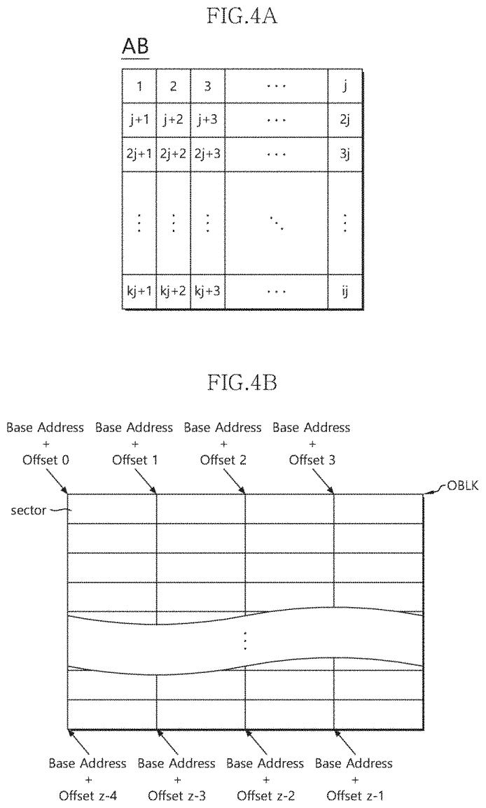

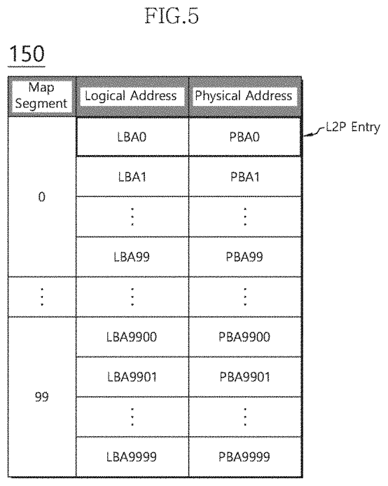

The second region 233 of the memory 230 may be used as an address buffer AB which stores mapping information representing relationships between write addresses received from the host device, i.e., logical block addresses (LBAs) and respective actual addresses of the nonvolatile memory device 100, i.e., physical block addresses (PBAs). The address buffer AB will be described below with reference to FIG. 4A.

The third region 234 of the memory 230 may be used as a map segment buffer MSB for storing one or more map segments of a plurality of map segments MS0 to MS99 (see FIG. 5) which are included in an address mapping table (AMT) 150 (see FIGS. 1 and 5). The map segments stored in the map segment buffer MSB may be used for a valid information update entry generation operation or a map update operation.

FIG. 3A illustrates the FTL.

Referring to FIG. 3A, the FTL may include a map module MM and a valid information management module VIMM. However, the present invention is not limited to this specific configuration; the FLT may include other various function modules. For example, the FTL may further include a read module, a write module, a garbage collection module, a wear-leveling module, a bad block management module and the like, as is known in the art. The function modules included in the FTL may be driven by control of the processor 220.

The map module MM may manage the nonvolatile memory device 100 and the memory 230 to perform operations related to map data. The operations related to the map data may include an address mapping (or translation) operation, a map update operation, a map cache operation and the like, but the present invention is not limited to these specific operations.

When a write request, a logical block address and write data are provided from the host device, the map module MM may store the logical block address in a region of the address buffer AB, corresponding to a physical block address in which the write data is to be stored. In this way, the logical block address may be mapped to the physical block address. The physical block address mapped to the logical block address in the address buffer AB may be the latest mapping information indicating the region in which the write data is to be stored within the nonvolatile memory device 100.

The map module MM may control the nonvolatile memory device 100 and the memory 230 to read from the nonvolatile memory device 100 one or more map segments including the logical block address provided from the host device and to store the read one or more map segments in the map segment buffer MSB of the memory 230. The physical block address corresponding to the logical block address within the map segment may be old mapping information.

The valid information management module VIMM may manage information related to valid data included in a plurality of memory blocks (not illustrated) included in the nonvolatile memory device 100.

The nonvolatile memory device 100 configured as a flash memory device may not support a data overwrite operation due to its structural characteristics. When data is rewritten to a region in which data is stored, the reliability of the data stored in the corresponding region may not be guaranteed. Thus, in order to write data to a region in which data is stored, an erase operation needs to be first performed on the corresponding region.

However, since the erase operation for the nonvolatile memory device 100 requires a considerably long time because the erase operation is performed on a memory block basis, the processor 220 may write data, which is stored in a region corresponding to a logical block address to be written, to another region which is in an erase state, when the data is stored in the corresponding region. In this case, the data stored in the another region may become valid data as the latest data, and the data stored in the original region may become invalid data as old data. Thus, valid data and invalid data may be mixed in the memory blocks of the nonvolatile memory device 100.

When the number of free blocks included in the nonvolatile memory device 100 becomes equal to or less than a preset threshold count, the processor 220 may perform a garbage collection operation on the nonvolatile memory device 100. The garbage collection operation may refer to a series of operations of selecting a victim block among the memory blocks included in the nonvolatile memory device 100, and changing the victim block to a free block by moving valid data from the victim block to a target block. The free block may indicate an available memory block including only invalid data.

When the garbage collection operation is performed, the locations where the valid data are stored in the victim block need to be identified. Information related to the locations of the valid data within the respective memory blocks may be managed through a valid page bitmap table VPBMT. The valid page bitmap table VPBMT may be separately generated and managed for each of the memory blocks included in the nonvolatile memory device 100. The valid page bitmap table VPBMT will be described below with reference to FIG. 3E.

FIG. 3B illustrates the metadata region 232 included in the first region 231 of the memory 230.

Referring to FIG. 3B, the metadata region 232 may include a valid information update entry list VIUEL and a valid information storage region VISR, but the present invention is not limited to this specific configuration. Although not illustrated in FIG. 3B, various metadata for driving various function modules included in the FTL may be stored in the metadata region 232, as is known in the art.

FIG. 3C illustrates the valid information update entry list VIUEL.

Referring to FIG. 3C, the valid information update entry list VIUEL may include one or more valid information update entries VIUE. The valid information update entry VIUE may include a start physical block address (Start PBA), a length (Length) and a value (Valid) indicating whether the entry is valid. The start physical block address (Start PBA) may include a memory block number (BLK Number) and an offset (Offset). The length (Length) may indicate the number of consecutive physical block addresses including the start physical block address (Start PBA).

The valid information update entry list VIUEL may be generated and stored by the valid information management module VIMM. The valid information update entry list VIUEL may include valid entries including physical block addresses indicating regions within memory blocks in which valid data are stored, and invalid entries including physical block addresses indicating regions within memory blocks in which invalid data are stored.

For example, when sequential write requests and sequential logical block addresses are received from the host device and the sequential logical block addresses are sequentially mapped to consecutive physical block addresses of the address buffer AB, the valid information management module VIMM may identify the start physical block address of the consecutive physical block addresses mapped to the sequential logical block addresses by referring to the mapping information of the address buffer AB, count the number of the consecutive physical block addresses including the start physical block address, and generate the valid information update entry VIUE of the consecutive physical block addresses based on the start physical block address and the count value. The valid information update entry VIUE which is generated based on the mapping information of the address buffer AB may be referred to as a valid entry.

Also, when sequential write requests and sequential logical block addresses are received from the host device, the map module MM may read one or more map segments including the sequential logical block addresses from the nonvolatile memory device 100, and store the read map segment(s) in the map segment buffer MSB of the memory 230.

The valid information management module VIMM may identify the start physical block address of the physical block addresses mapped to the sequential logical block addresses received from the host device within the map segments stored in the map segment buffer MSB, count the number of the consecutive physical block addresses including the start physical block address, and generate the valid information update entry VIUE of the physical block addresses included in the map segments based on the count value. The valid information update entry VIUE generated based on the map segments stored in the map segment buffer MSB may be referred to an invalid entry.

That is, when sequential write requests and sequential logical block addresses are received from the host device, the map module MM may generate an invalid entry for physical block addresses which had been mapped to the sequential logical block addresses within the map segments stored in the map segment buffer MSB, and generate a valid entry for physical block addresses which are newly assigned for and mapped to the sequential logical block addresses, based on the mapping information stored in the address buffer AB.

FIG. 3D illustrates a valid information storage region VISR, and FIG. 3E illustrates a valid page bitmap table VPBMT.

Referring to FIG. 3D, the valid information storage region VISR may include a plurality of valid page bitmap tables VPBMT0 to VPBMTx−1. The valid page bitmap tables VPBMT0 to VPBMTx−1 may respectively correspond to the memory blocks included in the nonvolatile memory device 100. The memory blocks included in the nonvolatile memory device 100 may indicate a region obtained by grouping all or some of the plurality of memory blocks or a unit defined by a single memory block.

Referring to FIG. 3E, the valid page bitmap table VPBMT may include a plurality of bits. The bits included in the valid page bitmap table VPBMT may respectively correspond to write units, for example, sectors (shown in FIG. 4B) included in a memory block corresponding to the valid page bitmap table VPBMT. For example, when a single logical block address corresponds to a single sector (refer to FIG. 4B) and z sectors are included in a memory block, the valid page bitmap table VPBMT corresponding to the memory block may include z bits, where z is any suitable whole number. Each of the bits included in the valid page bitmap table VPBMT may have a value indicating whether data stored in a corresponding sector is valid data or invalid data within a memory block corresponding to the valid page bitmap table VPBMT.

FIG. 4A illustrates the address buffer AB, and FIG. 4B illustrates an open memory block OBLK.

Referring to FIG. 4A, the address buffer AB may include a plurality of regions 1 to ij represented as columns in FIG. 4A. Logical block addresses received with write requests from the host device may be sequentially stored in the respective regions 1 to ij.

Referring to FIG. 4B, the open memory block OBLK may include a plurality of sectors. The open memory block OBLK may indicate a memory block assigned by the processor 220 in order to store write data received from the host device. The open memory block OBLK may indicate a portion or all of a single memory block or a region represented by some or all of the memory blocks grouped together. In the context of the present description, the open memory block OBLK is all of a single memory block.

As illustrated in FIG. 4B, each of the sectors of the open memory block OBLK may have a unique physical block address. For example, the physical block address of each of the sectors may be expressed as the sum of a base address and an offset. When the open memory block OBLK includes z sectors as illustrated in FIG. 4B, the physical block address of the first sector may be expressed as ‘base address+offset 0’, and the physical block addresses of the second to z^{th} sectors may be expressed as ‘base address+offset 1’ to ‘base address+offset z−1’.

Although not illustrated in the drawings, the open memory block OBLK may have its own block number, and the processor 220 may acquire the block number when assigning the open memory block OBLK.

Referring to FIGS. 4A and 4B, the regions 1 to ij of the address buffer AB may correspond to the physical block addresses indicating the respective sectors of the open memory block OBLK. For example, the region ‘1’ of the address buffer AB may correspond to the physical block address ‘base address+offset 0’ indicating the first sector of the open memory block OBLK, and the region ‘ij’ of the address buffer AB may correspond to the physical block address ‘base address+offset z−1’ indicating the z^{th} sector of the open memory block OBLK. That is, the regions included in the address buffer AB may respectively correspond to the sectors included in the open memory block OBLK. Furthermore, the order of the regions included in the address buffer AB may be equal to the order of the sectors included in the open memory block OBLK. Based on this configuration, the map module MM may check the physical block addresses mapped to the logical block addresses stored in the respective regions 1 to ij of the address buffer AB.

FIG. 5 illustrates the AMT 150 of FIG. 1.

Referring to FIG. 5, the AMT 150 may include a plurality of map segments. Each of the map segments may include a plurality of logical to physical (L2P) entries. Each of the L2P entries may include one physical block address and one logical block address mapped to each other. The logical block addresses included in each of the map segments may be aligned and fixed in ascending order, but the present invention is not limited to this specific ordered arrangement. The physical block addresses mapped to the respective logical block addresses in the map segment may be updated. By way of example, FIG. 5 illustrates that the AMT 150 includes 100 map segments 0 to 99, and each of the map segments 0 to 99 includes 100 L2P entries. However, the number of the map segments and the number of the L2P entries per map segment are not limited thereto.

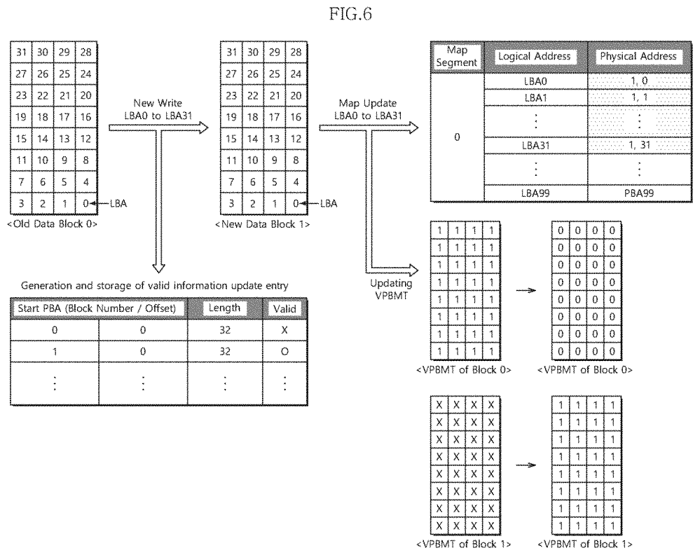

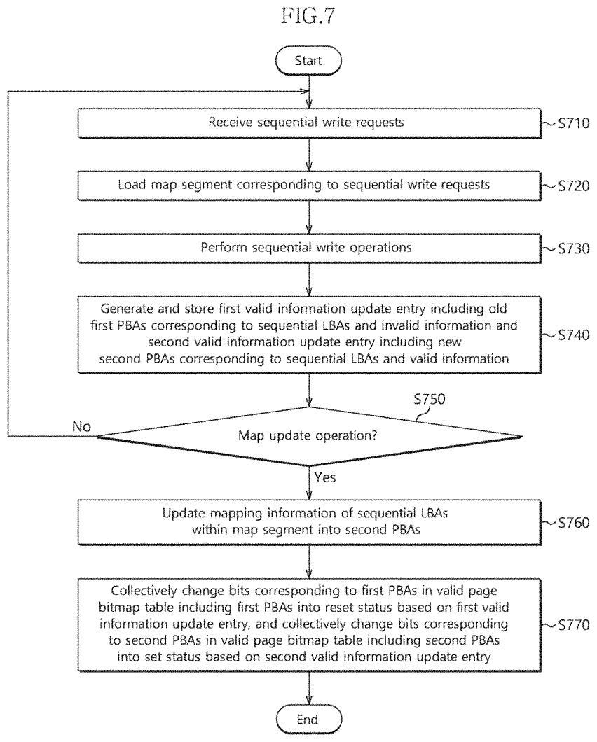

FIG. 6 illustrates a process of generating and storing the valid information update entries (VIUEs) and updating the valid page bitmap table VPBMT in accordance with an embodiment. Bits of the VPBMT may be updated all at once. By way of example, the process is described in the context of a single memory block having 32 sectors that can store data having a size corresponding to 32 logical block addresses.

Referring to FIG. 6, when a write request for logical block addresses LBA0 to LBA31 is received from the host device while data corresponding to the logical block addresses LBA0 to LBA31 are stored in a block ‘0’, the processor 220 may control the nonvolatile memory device 100 (refer to FIG. 1) to assign a block ‘1’, which is a free block, as an open block, and to store the data corresponding to the logical block addresses LBA0 to LBA31 in the assigned block ‘1’.

Although not illustrated in FIG. 6, the map module MM may read a map segment ‘0’ (refer to FIG. 5) including the logical block addresses LBA0 to LBA31 from the AMT 150 (refer to FIG. 5) of the nonvolatile memory device 100 and store the read map segment ‘0’ in the map segment buffer MSB (refer to FIG. 2) of the memory 230 (refer to FIG. 1), before a write operation is performed on the block ‘1’ for storing the data corresponding to the logical block addresses LBA0 to LBA31. On the other hand, the map module MM may sequentially store the received logical block addresses LBA0 to LBA31 in regions of the address buffer AB so as to map the received logical block addresses LBA0 to LBA31 to new physical block addresses indicating the sectors that store the data corresponding to the received logical block addresses LBA0 to LBA31 within the block ‘1’.

While the write operation for storing the data corresponding to the logical block addresses LBA0 to LBA31 is performed on the block ‘1’, the valid information management module VIMM may generate an invalid entry corresponding to the old data block ‘0’ based on the map segment ‘0’ stored in the map segment buffer MSB and store the generated invalid entry in the valid information update entry list, and generate a valid entry corresponding to the new data block ‘1’ based on the mapping information of the address buffer AB and store the generated valid entry in the valid information update entry list.

Then, when a map update operation for the logical block addresses LBA0 to LBA31 is performed, the map module MM may change physical block addresses corresponding to the respective logical block addresses LBA0 to LBA31 in the map segment ‘0’ which includes the logical block addresses LBA0 to LBA31 and is stored in the map segment buffer MSB, and store the changed map segment in the map segment buffer MSB. Furthermore, the map module MM may store the map segment ‘0’, in which the physical block addresses of the logical block addresses LBA0 to LBA31 are changed, in the AMT 150 of the nonvolatile memory device 100.

Simultaneously, the valid information management module VIMM may collectively update bits of the valid page bitmap table VPBMT corresponding to the block ‘0’ to ‘reset (0)’ indicating invalid data, based on the invalid entries stored in the valid information update entry list. Furthermore, the valid information management module VIMM may collectively update bits of the valid page bitmap table VPBMT corresponding to the block ‘1’ to ‘set (1)’ indicating valid data, based on the valid entries stored in the valid information update entry list. The operation of collectively changing the values of the bits of the valid page bitmap table VPBMT based on the invalid entries and the valid entries may be performed through a “memset” function, which is known, but the present invention is not limited thereto. An equivalent function may be used instead. The memset function may be used when setting all values within a consecutive range from a certain start point to the same value.

In an embodiment, the bits indicating whether the data included in each of the memory blocks are valid or invalid may be collectively updated through the memset function, which makes it possible to reduce an overhead required for valid data management for each of the memory blocks.

FIG. 7 is a flowchart illustrating an operating method of the data storage device in accordance with an embodiment. In describing such method, one or more of FIGS. 1 to 6 may be referred to, in addition to FIG. 7.

At step S710, sequential write requests may be received from the host device. Sequential logical block addresses and write data may be received with the sequential write requests.

At step S720, the processor 220 of the controller 200 may control the nonvolatile memory device 100 and the memory 230 to drive the map module MM such that one or more map segments including the sequential logical block addresses received at step S710 are read from the AMT 150 of the nonvolatile memory device 100 and stored in the map segment buffer MSB of the memory 230. Within the map segments, physical block addresses corresponding to the sequential logical block addresses received at step S710 may be old physical block addresses.

At step S730, the processor 220 may control the nonvolatile memory device 100 to perform a write operation in response to the sequential write requests received from the host device. Through the write operation, write data corresponding to the sequential logical block addresses received at step S710 may be stored in sectors of an open memory block and the sectors may correspond to new consecutive physical block addresses.

For example, the processor 220 may drive the map module MM to sequentially map and store the sequential logical block addresses received from the host device to the corresponding positions of the address buffer AB of the memory 230, thereby translating the sequential logical block addresses to the consecutive physical block addresses. Furthermore, the processor 220 may provide the nonvolatile memory device 100 with the translated physical block addresses, sequential write commands and write data. The nonvolatile memory device 100 may store the write data in sectors corresponding to the consecutive physical block addresses in response to the sequential write commands received from the processor 220.

At step S740, the valid information management module VIMM may generate a first valid information update entry (i.e. invalid entry) including the old physical block addresses PBAs corresponding to the sequential logical block addresses LBAs and invalid information, based on the map segment stored in the map segment buffer MSB, and store the first valid information update entry in the valid information update entry list. Furthermore, the valid information management module VIMM may generate a second valid information update entry (i.e. valid entry) including the new consecutive physical block addresses PBAs corresponding to the sequential logical block addresses LBAs and valid information, based on the mapping information of the address buffer AB, and store the generated second valid information update entry in the valid information update entry list.

At step S750, the processor 220 may determine whether to perform a map update operation. For example, the operation of determining whether to perform the map update operation may be performed by determining whether logical block addresses are mapped to all regions within the address buffer AB. However, the present invention is not limited thereto; other conditions for determining whether to perform the map update operation may be used. When the map update operation does not need to be performed (that is, “No” at step S750), the procedure may proceed to step S710. When the map update operation needs to be performed (that is, “Yes” at step S750), the procedure may proceed to step S760.

At step S760, the map module MM may change the mapping information on the sequential logical block addresses LBAs included in the map segment stored in the map segment buffer MSB to the new physical block addresses PBAs.

At step S770, the valid information management module VIMM may collectively change, through the memset function, bits to ‘reset (0)’ based on the first valid information update entry, i.e. the invalid entry, the bits corresponding to the old physical block addresses PBAs in the valid page bitmap table VPBMT including the old physical block addresses PBAs. Furthermore, the valid information management module VIMM may collectively change, through the memset function, bits to ‘set (1)’ based on the second valid information update entry, i.e. the valid entry, the bits corresponding to the new physical block addresses PBAs in the valid page bitmap table VPBMT including the new physical block addresses PBAs.

In accordance with embodiments of the present invention, since the data storage device can collectively update information indicating whether data included in the respective memory blocks are valid or invalid, the data storage device can reduce overhead required for managing valid data for the respective memory blocks.

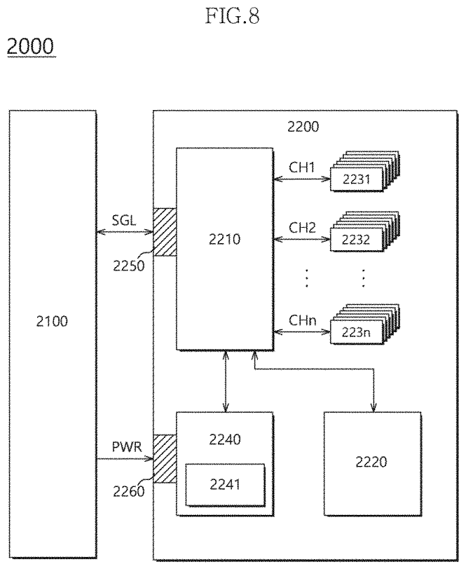

FIG. 8 illustrates a data processing system including a solid state drive (SSD) in accordance with an embodiment. Referring to FIG. 8, a data processing system 2000 may include a host apparatus 2100 and a SSD 2200.

The SSD 2200 may include a controller 2210, a buffer memory device 2220, nonvolatile memory devices 2231 to 223n, a power supply 2240, a signal connector 2250, and a power connector 2260.

The controller 2210 may control an overall operation of the SSD 2220.

The buffer memory device 2220 may temporarily store data to be stored in the nonvolatile memory devices 2231 to 223n. The buffer memory device 2220 may temporarily store data read from the nonvolatile memory devices 2231 to 223n. The data temporarily stored in the buffer memory device 2220 may be transmitted to the host apparatus 2100 or the nonvolatile memory devices 2231 to 223n according to control of the controller 2210.

The nonvolatile memory devices 2231 to 223n may be used as a storage medium of the SSD 2200. The nonvolatile memory devices 2231 to 223n may be coupled to the controller 2210 through a plurality of channels CH1 to CHn. One or more nonvolatile memory devices may be coupled to one channel. The nonvolatile memory devices coupled to the one channel may be coupled to the same signal bus and the same data bus.

The power supply 2240 may provide power PWR input through the power connector 2260 to the inside of the SSD 2200. The power supply 2240 may include an auxiliary power supply 2241. The auxiliary power supply 2241 may supply the power so that the SSD 2200 is properly terminated even when sudden power-off occurs. The auxiliary power supply 2241 may include large capacity capacitors capable of charging the power PWR.

The controller 2210 may exchange a signal SGL with the host apparatus 2100 through the signal connector 2250. The signal SGL may include a command, an address, data, and the like. The signal connector 2250 may be configured as any of various types of connectors according to an interfacing method between the host apparatus 2100 and the SSD 2200.

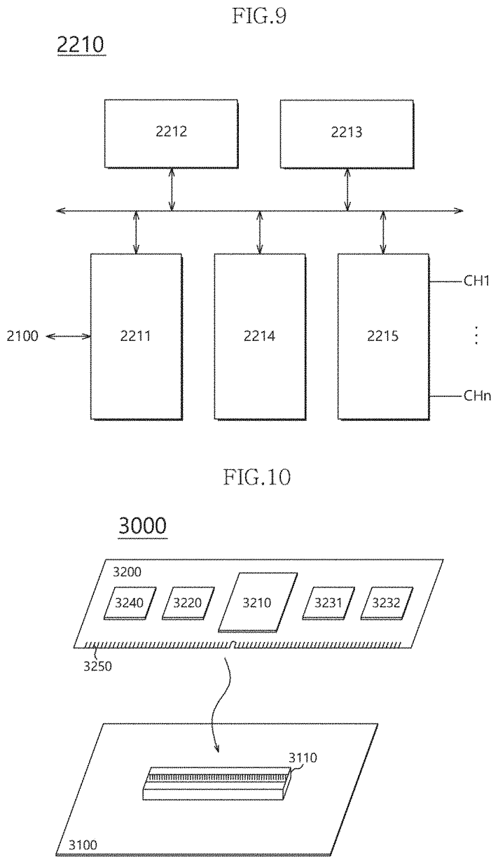

FIG. 9 illustrates the controller 2210 of FIG. 9. Referring to FIG. 8, the controller 2210 may include a host interface 2211, a control component 2212, a random access memory (RAM) 2213, an error correction code (ECC) component 2214, and a memory interface 2215.

The host interface 2211 may perform interfacing between the host apparatus 2100 and the SSD 2200 according to a protocol of the host apparatus 2100. For example, the host interface 2211 may communicate with the host apparatus 2100 through any of a secure digital protocol, a universal serial bus (USB) protocol, a multimedia card (MMC) protocol, an embedded MMC (eMMC) protocol, a personal computer memory card international association (PCMCIA) protocol, a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, a PCI Express (PCI-E) protocol, and a universal flash storage (UFS) protocol. The host interface 2211 may perform a disc emulation function that the host apparatus 2100 recognizes the SSD 2200 as a general-purpose data storage apparatus, for example, a hard disc drive HDD.

The control component 2212 may analyze and process the signal SGL input from the host apparatus 2100. The control component 2212 may control operations of internal functional blocks according to firmware and/or software for driving the SDD 2200. The RAM 2213 may be operated as a working memory for driving the firmware or software.

The ECC component 2214 may generate parity data for the data to be transferred to the nonvolatile memory devices 2231 to 223n. The generated parity data may be stored in the nonvolatile memory devices 2231 to 223n together with the data. The ECC component 2214 may detect errors for data read from the nonvolatile memory devices 2231 to 223n based on the parity data. When detected errors are within a correctable range, the ECC component 2214 may correct the detected errors.

The memory interface 2215 may provide a control signal such as a command and an address to the nonvolatile memory devices 2231 to 223n according to control of the control component 2212. The memory interface 2215 may exchange data with the nonvolatile memory devices 2231 to 223n according to control of the control component 2212. For example, the memory interface 2215 may provide data stored in the buffer memory device 2220 to the nonvolatile memory devices 2231 to 223n or provide data read from the nonvolatile memory devices 2231 to 223n to the buffer memory device 2220.

FIG. 10 illustrates a data processing system including a data storage apparatus in accordance with an embodiment. Referring to FIG. 10, a data processing system 3000 may include a host apparatus 3100 and a data storage apparatus 3200.

The host apparatus 3100 may be configured in a board form such as a printed circuit board (PCB). Although not shown in FIG. 10, the host apparatus 3100 may include internal functional blocks configured to perform functions of the host apparatus 3100.

The host apparatus 3100 may include a connection terminal 3110 such as a socket, a slot, or a connector. The data storage apparatus 3200 may be mounted on the connection terminal 3110.

The data storage apparatus 3200 may be configured in a board form such as a PCB. The data storage apparatus 3200 may refer to a memory module or a memory card. The data storage apparatus 3200 may include a controller 3210, a buffer memory device 3220, nonvolatile memory devices 3231 to 3232, a power management integrated circuit (PMIC) 3240, and a connection terminal 3250.

The controller 3210 may control an overall operation of the data storage apparatus 3200. The controller 3210 may be configured to have the same configuration as the controller 2210 illustrated in FIG. 9.

The buffer memory device 3220 may temporarily store data to be stored in the nonvolatile memory devices 3231 and 3232. The buffer memory device 3220 may temporarily store data read from the nonvolatile memory devices 3231 and 3232. The data temporarily stored in the buffer memory device 3220 may be transmitted to the host apparatus 3100 or the nonvolatile memory devices 3231 and 3232 according to control of the controller 3210.

The nonvolatile memory devices 3231 and 3232 may be used as a storage medium of the data storage apparatus 3200.

The PMIC 3240 may provide power input through the connection terminal 3250 to the inside of the data storage apparatus 3200. The PMIC 3240 may manage the power of the data storage apparatus 3200 according to control of the controller 3210.

The connection terminal 3250 may be coupled to the connection terminal 3110 of the host apparatus 3100. A signal such as a command, an address, and data and power may be transmitted between the host apparatus 3100 and the data storage apparatus 3200 through the connection terminal 3250. The connection terminal 3250 may be configured in various forms according to an interfacing method between the host apparatus 3100 and the data storage apparatus 3200. The connection terminal 3250 may be arranged in any one side of the data storage apparatus 3200.

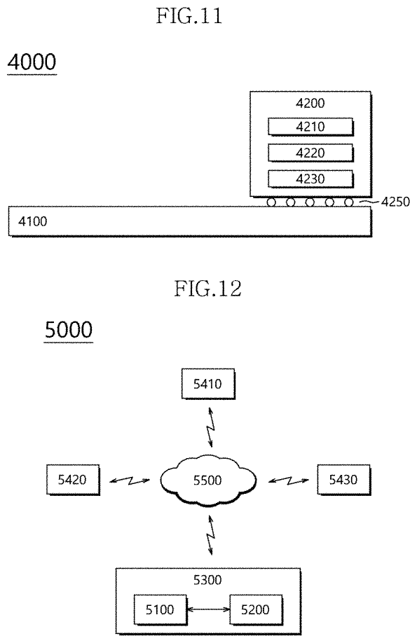

FIG. 11 illustrates a data processing system including a data storage apparatus in accordance with an embodiment. Referring to FIG. 11, a data processing system 4000 may include a host apparatus 4100 and a data storage apparatus 4200.

The host apparatus 4100 may be configured in a board form such as a PCB. Although not shown in FIG. 11, the host apparatus 4100 may include internal functional blocks configured to perform functions of the host apparatus 4100.

The data storage apparatus 4200 may be configured in a surface mounting packaging form. The data storage apparatus 4200 may be mounted on the host apparatus 4100 through a solder ball 4250. The data storage apparatus 4200 may include a controller 4210, a buffer memory device 4220, and a nonvolatile memory device 4230.

The controller 4210 may control an overall operation of the data storage apparatus 4200. The controller 4210 may be configured to have the same configuration as the controller 2210 illustrated in FIG. 9.

The buffer memory device 4220 may temporarily store data to be stored in the nonvolatile memory device 4230. The buffer memory device 4220 may temporarily store data read from the nonvolatile memory device 4230. The data temporarily stored in the buffer memory device 4220 may be transmitted to the host apparatus 4100 or the nonvolatile memory device 4230 through control of the controller 4210.

The nonvolatile memory device 4230 may be used as a storage medium of the data storage apparatus 4200.

FIG. 12 illustrates a network system 5000 including a data storage apparatus in accordance with an embodiment. Referring to FIG. 12, the network system 5000 may include a server system 5300 and a plurality of client systems 5410 to 5430 which are coupled through a network 5500.

The server system 5300 may serve data in response to requests of the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host apparatus 5100 and a data storage apparatus 5200. The data storage apparatus 5200 may be configured of the electronic apparatus 10 of FIG. 1, the data storage apparatus 2200 of FIG. 8, the data storage apparatus 3200 of FIG. 10, or the data storage apparatus 4200 of FIG. 11.

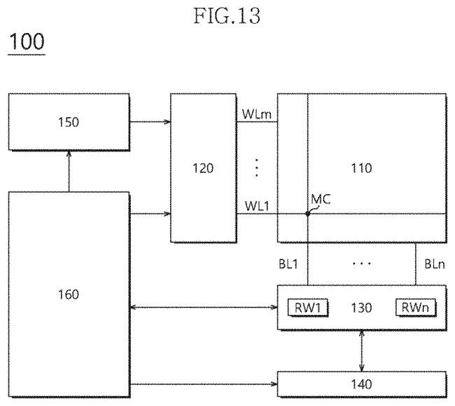

FIG. 13 illustrates a nonvolatile memory device included in a data storage apparatus in accordance with an embodiment. Referring to FIG. 13, a nonvolatile memory device 100 may include a memory cell array 110, a row decoder 120, a column decoder 140, a data read/write block 130, a voltage generator 150, and control logic 160.

The memory cell array 110 may include memory cells MC arranged in regions in which word lines WL1 to WLm and bit lines BL1 to BLn cross to each other.

The row decoder 120 may be coupled to the memory cell array 110 through the word lines WL1 to WLm. The row decoder 120 may operate through control of the control logic 160. The row decoder 120 may decode an address provided from an external apparatus (not shown). The row decoder 120 may select and drive the word lines WL1 to WLm based on a decoding result. For example, the row decoder 120 may provide a word line voltage provided from the voltage generator 150 to the word lines WL1 to WLm.

The data read/write block 130 may be coupled to the memory cell array 110 through the bit lines BL1 to BLn. The data read/write block 130 may include read/write circuits RW1 to RWn corresponding to the bit lines BL1 to BLn. The data read/write block 130 may operate according to control of the control logic 160. The data read/write block 130 may operate as a write driver or a sense amplifier according to an operation mode. For example, the data read/write block 130 may operate as the write driver configured to store data provided from an external apparatus in the memory cell array 110 in a write operation. In another example, the data read/write block 130 may operate as the sense amplifier configured to read data from the memory cell array 110 in a read operation.

The column decoder 140 may operate though control of the control logic 160. The column decoder 140 may decode an address provided from an external apparatus (not shown). The column decoder 140 may couple the read/write circuits RW1 to RWn of the data read/write block 130 corresponding to the bit lines BL1 to BLn and data input/output (I/O) lines (or data I/O buffers) based on a decoding result.

The voltage generator 150 may generate voltages used for an internal operation of the nonvolatile memory device 100. The voltages generated through the voltage generator 150 may be applied to the memory cells of the memory cell array 110. For example, a program voltage generated in a program operation may be applied to word lines of memory cells in which the program operation is to be performed. In another example, an erase voltage generated in an erase operation may be applied to well regions of memory cells in which the erase operation is to be performed. In another example, a read voltage generated in a read operation may be applied to word lines of memory cells in which the read operation is to be performed.

The control logic 160 may control an overall operation of the nonvolatile memory device 100 based on a control signal provided from an external apparatus. For example, the control logic 160 may control an operation of the nonvolatile memory device 100 such as a read operation, a write operation, an erase operation of the nonvolatile memory device 100.

While various embodiments have been illustrated and described, it will be understood to those skilled in the art that the embodiments described are examples only. Accordingly, the present invention is not limited based on the described embodiments. Rather, the present invention encompasses all variations and modifications that fall within the scope of the claims and their equivalents.

What is claimed is:

1. A data storage device comprising:
a nonvolatile memory device comprising a first memory block and a second memory block; and
a processor configured to:
generate an invalid entry including first physical block addresses of the first memory block corresponding to sequential logical block addresses, and generate a valid entry including second physical block addresses of the second memory block, in which data for the sequential logical block addresses are to be stored, when the sequential logical block addresses corresponding to data stored in the first memory block and a write request are received from a host device,
is collectively change, based on the invalid entry, bits corresponding to the first physical block addresses in a first valid page bitmap table of the first memory block to a first value, and
collectively change, based on the valid entry, bits corresponding to the second physical block addresses in a second valid page bitmap table of the second memory block to a second value.

2. The data storage device according to claim 1,
wherein the nonvolatile memory device comprises an address mapping table, and
wherein the processor reads one or more map segments including the sequential logical block addresses from the address mapping table, stores the read one or more map segments in a memory, and generates the invalid entry based on the one or more map segments.

3. The data storage device according to claim 2,
wherein the memory comprises an address buffer configured to sequentially map and store the sequential logical block addresses, and
wherein the processor generates the valid entry based on mapping information of the sequential logical block addresses in the address buffer.

4. The data storage device according to claim 1, wherein the processor generates the invalid entry and the valid entry while a write operation is performed in the second memory block of the nonvolatile memory device.

5. The data storage device according to claim 1, wherein, while a map update operation for the sequential logical block addresses is performed, the processor collectively changes the bits corresponding to the first physical block addresses to the first value, and collectively changes the bits corresponding to the second physical block addresses to the second value.

6. The data storage device according to claim 1, wherein the processor collectively changes the bits corresponding to the first physical block addresses to the first value and collectively changes the bits corresponding to the second physical block addresses to the second value, using a memset function.

7. The data storage device according to claim 1, wherein the first value indicates a reset state, and the second value indicates a set state.

8. The data storage device according to claim 1, further comprising a memory configured to store a flash translation layer (FTL) including a map module and a valid information management module.

9. The data storage device according to claim 8, wherein the processor drives the valid information management module to generate the invalid entry and the valid entry, collectively changes the bits corresponding to the first physical block addresses to the first value, using the invalid entry, and collectively changes the bits corresponding to the second physical block addresses to the second value, using the valid entry.

10. The data storage device according to claim 1,
wherein the invalid entry comprises a start physical block address of the first physical block addresses, length information, and information indicating whether the entry is invalid, and
wherein the valid entry comprises a start physical block address of the second physical block addresses, length information, and information indicating whether the entry is valid.

11. The data storage device according to claim 10, wherein the start physical block address comprises a memory block number and an offset.

12. An operating method of a data storage device, comprising:
receiving a write request and sequential logical block addresses from a host device;
loading on a memory one or more map segments including the sequential logical block addresses from a nonvolatile memory device;
controlling the nonvolatile memory device to perform a write operation according to the write request;
generating an invalid entry including first physical block addresses corresponding to the sequential logical block addresses and a valid entry including second physical block addresses corresponding to the sequential logical block addresses; and
collectively changing bits corresponding to the first physical block addresses to a first value within an invalid page bitmap table based on the invalid entry, and collectively changing bits corresponding to the second physical block addresses to a second value within a valid page bitmap table based on the valid entry.

13. The operating method according to claim 12, wherein the controlling of the nonvolatile memory device to perform the write operation according to the write request comprises:
translating the sequential logical block addresses to the second physical block addresses by sequentially mapping the sequential logical block addresses to regions within an address buffer, respectively, and storing the mapped sequential logical block addresses; and
providing the nonvolatile memory device with the second physical block addresses, a write command corresponding to the write request, and write data.

14. The operating method according to claim 13,
wherein the generating of the valid entry is performed based on the second physical block addresses mapped to the sequential logical block addresses in the address buffer, and
wherein the valid entry comprises a start physical block address of the second physical block addresses, length information, and information indicating whether the entry is valid.

15. The operating method according to claim 12,
wherein the generating of the invalid entry is performed based on the first physical block addresses mapped to the sequential logical block addresses in the one or more map segments, and
wherein the invalid entry comprises a start physical block address of the first physical block addresses, length information, and information indicating whether the entry is invalid.

16. The operating method according to claim 12, wherein the generating of the invalid entry and the valid entry is performed while the write operation is performed in the nonvolatile memory device.

17. The operating method according to claim 12, further comprising:
determining whether a map update operation for the sequential logical block addresses is needed; and
changing the first physical block addresses mapped to the sequential logical block addresses in the one or more map segments to the second physical block addresses, and storing the second physical block addresses.

18. The operating method according to claim 17, wherein the collectively changing the bits of the valid page bitmap table corresponding to the first physical block addresses to the first value and collectively changing the bits of the valid page bitmap table corresponding to the second physical block addresses to the second value is performed while the first physical block addresses mapped to the sequential logical block addresses are changed to the second physical block addresses and the second physical block addresses are stored.

19. A data storage device comprising:
a nonvolatile memory device, including a first block currently storing first data and an open second block, and configured to store first and second tables respectively indicating validity of data stored in each storage region within the first and second blocks; and
a control component configured to:
control the nonvolatile memory device to program second data into the second block; and
update the first table to indicate the first data as invalid and the second table to indicate the second data as valid,
wherein the first and second data correspond to the same sequential logical addresses.
